(19) United States
(12) Patent Application Publication
(10) Pub. No.: US 2019/0234484 A1
(43) Pub. Date: Aug. 1, 2019

(54) CLUTCH DAMPER ASSEMBLY

(71) Applicant: FORD GLOBAL TECHNOLOGIES, LLC, DEARBORN, MI (US)

(72) Inventor: ANTONS KUZENKO, BASILDON (GB)

(21) Appl. No.: 16/260,643

(22) Filed: Jan. 29, 2019

(30) Foreign Application Priority Data
Jan. 30, 2018 (GB) 1801522.2

(51) Int. Cl. F16F 15/129

(52) U.S. Cl. CPC F16F 15/129; F16F 2224/0291; F16F 15/12313; F16D 2300/22; F16F 2238/04

(57) ABSTRACT

A damper assembly for a clutch, the damper assembly being configured to transfer torque from a driven plate of the clutch to an output shaft of the clutch, a torque transfer plate of the damper assembly including at least one surface coating configured to alter the acoustic properties of the torque transfer plate.

### CROSS REFERENCE TO RELATED APPLICATIONS

The present application claims the benefit to UK patent application GB1801522.2, filed Jan. 30, 2018, the contents of which are incorporated herein in their entirety.

### BACKGROUND OF THE INVENTION

This disclosure relates to a damper assembly for a clutch, and in particular to coating a component of the damper assembly to reduce the noise, vibration and harshness associated with the operation of a clutch.

A vehicle is typically fitted with a clutch that is used to selectively engage and disengage the output shaft of a motor of the vehicle from a drivetrain of the vehicle. In some circumstances, the user of the vehicle may experience undesirable noises and acoustic phenomena while operating the vehicle. For example, the user may hear one or more noises, such as a heavy sound of an impact (a clonk) while operating the clutch and/or the transmission.

Such unwanted acoustic phenomena have been an issue for many years, but are generally caused by the backlash, or play, in the drivetrain of the vehicle. Such backlash is normally the result of inherent assembly tolerances, and can be made worse as components wear. In particular, it has been observed that the backlash between components of a clutch can contribute significantly to clonk.

More recently, with the introduction of increasingly strict efficiency and emissions requirements, it has become desirable to reduce the amount of friction between drivetrain components, which can lead to an increase in undesirable noises and acoustic phenomenon, such as rattle. One way in which rattle can be reduced is to increase the amount of backlash between components of a clutch. However, this can lead to higher levels of impact loading within the clutch, which can increase the levels of clonk perceived by the user.

### SUMMARY OF THE INVENTION

According to an aspect of the present disclosure there is provided a damper with a surface coating that may be configured to at least partially silence the torque transfer plate under impact loading, which can be of particular benefit where there is play, i.e. backlash, between the torque transfer plate and one or more other components that the torque transfer plate is operationally coupled to, such as an output shaft, or hub, of the clutch. The torque transfer plate is a component of a damper assembly of the clutch. The output shaft of the clutch may be configured to attach directly to an input shaft of a transmission.

The torque transfer plate may be coated in a combination of surface coatings. A first surface coating may be applied to a first region of the torque transfer plate. A second surface coating may be applied to a second region of the torque transfer plate.

The surface coating may be provided on at least a portion of an axial end face of the torque transfer plate. In an assembled configuration, the axial end face of the torque transfer plate may be in operational clearance with one or more other components, e.g. adjacent components of the clutch. The surface coating may be provided on at least a portion of a radial surface of the torque transfer plate. In an assembled configuration, the radial surface of the torque transfer plate may be configured to engage at least one other component of the clutch, so as to transfer torque to the at least one other component.

The torque transfer plate may comprise a central opening configured to receive the output shaft of the clutch. The torque transfer plate may comprise one or more projections, e.g. first projections, which extend radially inwards from the periphery of the opening. The first projections may be configured to rotationally couple the torque transfer plate to the output shaft in an assembled configuration, for example by virtue of engagement with one or more other projections, e.g. second projections, that extend radially outwards from the periphery of the output shaft. The surface coating may not be provided on at least one surface of each of the projections of the torque transfer plate. For example, when the surface coating is applied to the torque transfer plate, the process may involve masking at least a portion of at least one of the projections of the torque transfer plate. In this manner, the contact mechanics between the torque transfer plate and the output shaft may not be affected by the surface coating applied to the torque transfer plate.

The surface coating may be any appropriate coating that results in the acoustic properties of the torque transfer plate being altered such that the torque transfer plate is at least partially silenced when impacted by another object.

The surface coating may be formed from an acoustic damping material, for example a polymeric material. The surface coasting may be polytetrafluoroethylene. The surface coasting may have thickness of less than approximately 200 microns.

A clutch may be provided comprising one or more of the above mentioned torque transfer plates. A vehicle may be provided comprising one or more of the above mentioned clutches.

According to another aspect of the present disclosure there is provided a method of acoustically tuning a damper assembly for a clutch.

The method may comprise determining an acoustic property, e.g. a resonant property (natural frequency), of the torque transfer plate before applying the surface coating. The method may comprise determining the acoustic property of the torque transfer plate after applying the surface coating. The step of applying the surface coating comprises acoustically tuning the torque transfer plate to at least partially silence the torque transfer plate under impact loading. The step of acoustically tuning the torque transfer plate may comprise applying a first surface coating, determining the acoustic response of the torque transfer plate, and at least one of applying a second surface coating and removing a portion of the first surface coating. The first and second surface coatings may be different types of surface coating.

The disclosure may also provide software, such as a computer program or a computer program product for carrying out any of the methods described herein, and a computer readable medium having stored thereon a program for carrying out any of the methods described herein. A computer program embodying the disclosure may be stored on a computer-readable medium, or it could, for example, be in the form of a signal such as a downloadable data signal provided from an Internet website, or it could be in any other form.

To avoid unnecessary duplication of effort and repetition of text in the specification, certain features are described in relation to only one or several aspects or arrangements of the disclosure. However, it is to be understood that, where it is technically possible, features described in relation to any aspect or arrangement of the disclosure may also be used with any other aspect or arrangement of the disclosure.

### BRIEF DESCRIPTION OF THE DRAWINGS

For a better understanding of the present disclosure, and to show more clearly how it may be carried into effect, reference will now be made, by way of example, to the accompanying drawings, in which:

FIG. 1 shows a schematic exploded view of particular components of a clutch; and

FIG. 2 shows a schematic partial front view of the clutch.

### DETAILED DESCRIPTION

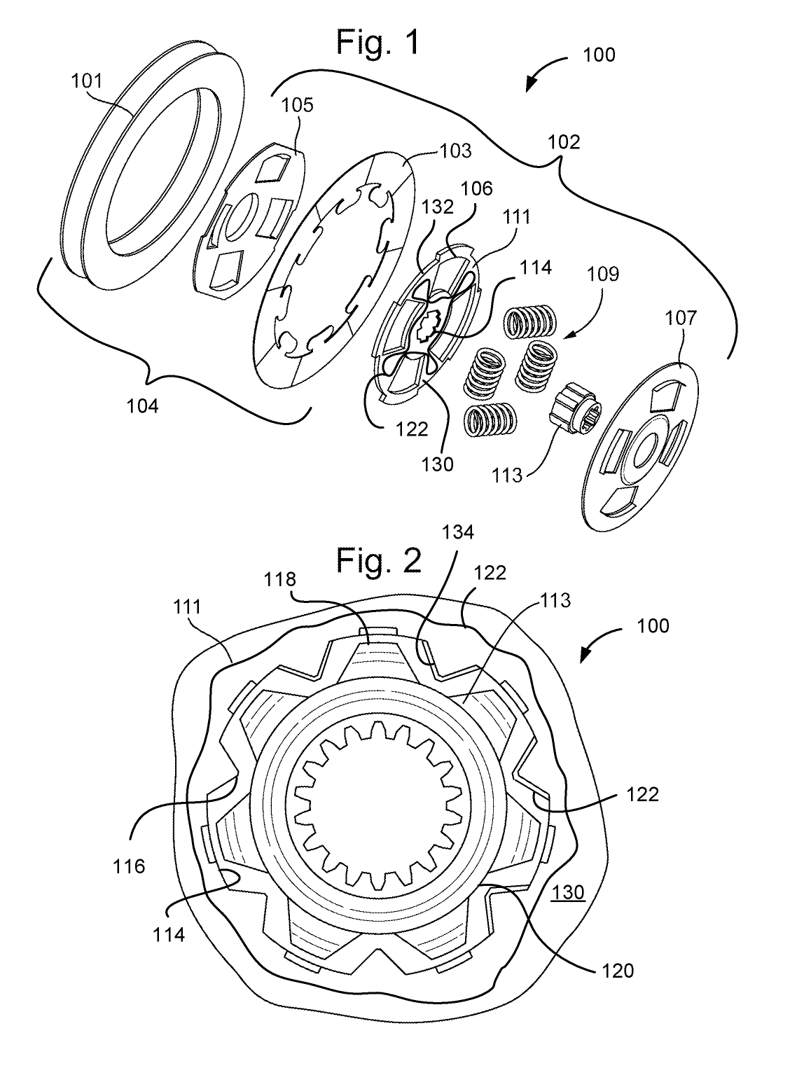

FIGS. 1 and 2 show a simplified exploded view of a clutch assembly 100 for a vehicle, the clutch assembly 100 allowing for the selective engagement and disengagement of an output shaft of a motor of the vehicle from a transmission of the vehicle, and/or another component of the drivetrain of the vehicle. The clutch may be any appropriate type of clutch configured for use on a vehicle, such a car, a van, a truck, a motor bike, a marine vessel or an aircraft. In particular, the clutch may be a single-mass flywheel clutch for use on a vehicle having a relatively small internal combustion engine. However, in another arrangement, the clutch may be a duel mass flywheel clutch, such as one used on commercial vehicles and/or vehicles with diesel engines. The engine and transmission may be conventional, if so desired, and so will not be shown herein.

The clutch assembly 100 may include a driven plate assembly 104 comprising a driven plate 101 and friction member 103, the driven plate assembly being configured to transfer torque from the engine to the clutch when the driven plate assembly is brought into engagement with a flywheel of the engine.

The clutch assembly 100 may include a damper assembly 102, which has first and second disc members 105, 107, respectively, which are rigidly secured to the driven plate assembly 104 in an assembled configuration. The first and second disc members 105, 107 cooperate to form a housing for a set of damper springs 109, a torque transfer plate 111 and an output shaft (hub member) 113 of the clutch 100. Each of the first and second disc members 105, 107 and the torque transfer plate 111 include a plurality of recesses (cut-outs) 106, that are each configured to receive and hold a respective damper spring of the damper spring set 109. When the damper assembly 102 is assembled to the driven plate assembly 104, the torque is transmitted directly from the driven plate assembly 104 to the first and second disc members 105, 107, through the damper spring set 109 to the torque transfer plate 111 and then the output shaft 113. In this manner, fluctuations in the torque output from the engine are damped by the damper assembly 102, which reduces the torque fluctuation seen by the output shaft 113 of the clutch assembly 100.

One will note, then, that the torque transfer plate 111 does not transfer the torque through surface friction between adjacent components pressed together axially. Thus, the axially facing surfaces (faces) 130 of the torque transfer plate 111 are non-frictional surfaces (i.e., there is no torque transferred via these faces 130 through frictional contact with an axially facing surface of another component in the clutch assembly 100 pressed against one of these faces 130. Accordingly, no frictional surface material for transferring torque is needed or employed on these faces 130. Additionally, teeth 116 that extend radially inward from a central opening 114 (discussed below), and mate with teeth 118 from the output shaft 113 (discussed below) are non-frictional surfaces in that the torque transfer is not through frictional contact but through normal (directionally speaking) contact between the surfaces.

FIG. 2, in view of FIG. 1, shows a view of the rotational coupling between the torque transfer plate 111 and the output shaft 113 of the clutch assembly 100. The torque transfer plate 111 includes a central opening 114 that axially receives the output shaft 113. The first and second disc members 105 support the output shaft 113 in the opening 114 of the torque transfer plate 111 such that there is a radial clearance between the outer diameter 120 of the output shaft 113 and the inner diameter 114 of the opening of the torque transfer plate 111. However, in one or more other arrangements, the output shaft 113 may be supported in any appropriate manner by one or more appropriate components of the clutch assembly 100.

The torque transfer plate 111 is rotationally coupled to the output shaft 113 by virtue of a plurality teeth that mesh with one another. For example, the torque transfer plate 111 may include a plurality of first teeth 116 that extend radially inward from the opening 114 of the torque transfer plate 111, and a plurality of second teeth 118 that extend radially outward from the outer diameter 120 of the output shaft 113. In some clutch arrangements (not shown), the teeth of the torque transfer plate 111 and the output shaft 113 are configured such that there is little backlash (play) between the teeth. However, the clutch shown in FIG. 2 comprises a substantial amount of backlash between the teeth 116 of the torque transfer plate 111 and the teeth 118 of the output shaft 113. The provision of such an amount of backlash enables the rotational interface between the torque transfer plate 111 and the output shaft 113 to function as a pre-damper stage of the clutch assembly 100, which acts to further reduce the transfer of torque fluctuations from the engine to the drivetrain.

However, with the introduction of increasingly strict efficiency and emissions requirements, it has become desirable to reduce the amount of friction between drivetrain components, which can lead to an increase in undesirable noises and acoustic phenomena, such as rattle. One way in which rattle can be reduced is to increase the amount of damping in the pre-damper stage of a clutch, i.e. by increasing the amount of backlash between the teeth 116 of the torque transfer plate 111 and the teeth 118 of the output shaft 113. However, this can lead to higher levels of impact loading within the pre-damper stage of a clutch assembly 100, e.g. as the teeth engage one another, which can increase the levels of clonk perceived by the user.

The present disclosure provides a clutch assembly 100 having improved noise vibration and harshness characteristics. In particular, the present disclosure provides the torque transfer plate 111 for the clutch assembly 100, the torque transfer plate 111 having improved acoustic properties, which result in a reduction in the audible noise, e.g. clonk, that can be heard while operating the clutch assembly 100.

The shape of the torque transfer plate 111 is a thin disc comprising cut-outs for the damper spring set 109. As a result of the inherent shape of the torque transfer plate 111, the torque transfer plate 111 has a natural frequency close to the operational frequencies encountered during its operation, which serves to amplify any impact sound inputs, resulting in undesirable audible sounds, such as clonk.

In order to alter the acoustic properties, e.g. the natural frequency of the torque transfer plate 111, the torque transfer plate 111 comprises a surface coating 122. For example, the torque transfer plate 111 may comprise a functional surface coating 122 configured to alter the acoustic properties of the torque transfer plate 111. In this manner, the acoustic response from the torque transfer plate 111 under impact sound inputs may be substantially different when compared to an un-coated torque transfer plate 111. Thus, the application of a surface coating 122 to a torque transfer plate 111 leads to a reduced level of undesirable audible sounds.

The surface coating 122 may be formed from any material having significant acoustic damping properties. In one arrangement, the surface coating 122 may be a polytetrafluoroethylene coating. The surface coating 122 may be applied using any appropriate coating process, such as vapor deposition, chemical and electrochemical techniques, spraying, roll-to-roll coating processes, and/or physical coating processes. Importantly, the surface coating 122 may be applied so as to not affect the design function of the torque transfer plate 111, i.e. its ability to transfer torque between the driven plate assembly and the output shaft of the clutch, e.g. by altering the shape and/or size of the torque transfer plate 111.

In one arrangement, the surface coating 122 may be applied over the entire outer surface of the torque transfer plate 111, e.g. over the axial end faces 130 and the radial outer 132 and inner 134 surfaces of the torque transfer plate 111. However, in some cases, it may be desirable to mask certain areas of the torque transfer plate 111 to prevent the surface coating 122 being applied to those areas. For example, the material of the torque transfer plate 111, and the output shaft 113, may be selected to optimize the interaction, e.g. contact mechanics, between the teeth 116 of the torque transfer plate 111 and the teeth 118 of the output shaft 113. In such circumstances, it may be desirable to not apply a surface coating 122 to the teeth 116 of the torque transfer plate 111, so as to not alter the interaction between the torque transfer plate 111 and the output shaft 113.

The present disclosure also provides a method of acoustically tuning a clutch component, such as the above mentioned torque transfer plate 111. For example, the method may comprise a step of determining the acoustic properties of the torque transfer plate 111, for example determining one or more resonant frequencies of the torque transfer plate 111. The method may comprise step of applying a surface coating 122 to the torque transfer plate 111 in order to adjust the determined acoustic properties.

It will be appreciated by those skilled in the art that although the disclosure has been described by way of example with reference to one or more arrangements, it is not limited to the disclosed arrangements and that alternative arrangements could be constructed without departing from the scope of the disclosure as defined by the appended claims.

1. A clutch comprising:
a driven plate;
an output shaft; and
a damper assembly, configured to transfer torque from the driven plate to the output shaft, including a torque transfer plate having an acoustic coating on at least one non-frictional surface of the torque transfer plate.

2. The clutch of claim 1 wherein the acoustic coating is on at least a portion of an axially facing face of the torque transfer plate.

3. The clutch of claim 2 wherein the acoustic coating is polytetrafluoroethylene.

4. The clutch of claim 2 wherein the acoustic coating is on at least a portion of a radially facing surface of the torque transfer plate.

5. The clutch of claim 1 wherein the acoustic coating is on at least a portion of a radially facing surface of the torque transfer plate.

6. The clutch of claim 5 wherein the acoustic coating is polytetrafluoroethylene.

7. The clutch of claim 1 wherein the torque transfer plate includes a central opening having teeth projecting radially inward therefrom, with the acoustic coating on at least a portion of the radially inward facing surfaces of the teeth.

8. The clutch of claim 7 wherein the output shaft extends through the central opening and includes radially outward extending teeth that selectively contact either the radially inward projecting teeth of the central opening or the acoustic coating.

9. The clutch of claim 1 wherein the acoustic coating covers the entire torque transfer plate.

10. The clutch of claim 9 wherein the acoustic coating is polytetrafluoroethylene.
